(19) United States
(12) Patent Application Publication
(10) Pub. No.: US 2026/0176488 A1
(43) Pub. Date: Jun. 25, 2026

(54) THERMOCHROMIC INK, PREPARATION METHOD THEREOF, AND PRINTED PRODUCT THEREOF

(71) Applicant: RR Donnelley (Guangdong) Printing Solutions Limited, Dongguan City (CN)

(72) Inventor: Weifeng XU, Dongguan City (CN)

(21) Appl. No.: 19/302,751

(22) Filed: Aug. 18, 2025

(30) Foreign Application Priority Data
Dec. 20, 2024 (CN) 2024118973983

(51) Int. Cl. C09D 11/50; C09D 11/107

(52) U.S. Cl. CPC C09D 11/50; C09D 11/107

(57) ABSTRACT

The present invention provides a thermochromic ink suitable for various printing methods, a preparation method thereof, and a printed product thereof. The ink comprises the following raw materials, in percentage by mass: 15 wt % to 45 wt % of aromatic polyurethane acrylic resin, 5 wt % to 45 wt % of modified epoxy acrylic resin, 5 wt % to 10 wt % of ethoxylated trimethylolpropane triacrylate, 5 wt % to 10 wt % of 1,6-hexanediol diacrylate, 5 wt % to 10 wt % of tetrahydrofuran acrylate, 5 wt % to 10 wt % of acryloylmorpholine, 5 wt % to 10 wt % of a co-initiator, 0.5 wt % to 1.5 wt % of polyethylene wax, 4 wt % to 10 wt % of a photosensitizer, 0.5 wt % to 1.5 wt % of a thermal stabilizer and 5 wt % to 15 wt % of calcium carbonate. By introducing resins prone to yellowing under high-temperature environments into the ink formulation and in combination with an excess of active photosensitizers, the coating of the ink according to the present invention can exhibit an excellent irreversible color-changing effect within specific high temperature ranges.

### TECHNICAL FIELD

The present invention relates to the technical field of inks and, in particular, to a thermochromic ink suitable for various printing methods, a preparation method thereof, and a printed product thereof.

### BACKGROUND

As a type of interesting anti-counterfeiting ink, the thermochromic ink has always appeared in people's daily life products with its amazing color-changing effect. Most thermochromic inks are reversible and can repeatedly present the required color change effect as the temperature changes. However, some thermochromic inks that are used as thermochromic materials in anti-counterfeiting products are irreversible, and such materials are generally applied in anti-counterfeiting product packaging, food packaging or various temperature-sensitive indicators.

For irreversible thermochromic inks currently available on the market, color changes typically occur within a temperature range of approximately 50° C. to 80° C., and thus, these inks may only achieve color-changing effects within the above limited temperature range, thereby limiting their applications. Furthermore, for these irreversible thermochromic materials on the market, they exhibit limited color changes, and typically, one temperature variation may cause only a single color change, resulting in a relatively boring visual effect. Such simplicity in functionality lowers the technical barrier to entry in the anti-counterfeiting materials sector.

The contents of the Background are merely technology known to the inventors and do not represent the prior art in this field.

### SUMMARY

To address at least one problem in the aforementioned prior art, a first object of the present application is to provide a thermochromic ink capable of exhibiting an irreversible, multi-stage color-changing effect across multiple temperature ranges. As the temperature increases, the color of the ink progressively darkens, thereby achieving anti-counterfeiting effects. The thermochromic ink includes the following raw materials, in percentage by mass:
15 wt % to 45 wt % of aromatic polyurethane acrylic resin, 5 wt % to 45 wt % of modified epoxy acrylic resin, 5 wt % to 10 wt % of ethoxylated trimethylolpropane triacrylate, 5 wt % to 10 wt % of 1,6-hexanediol diacrylate, 5 wt % to 10 wt % of tetrahydrofuran acrylate, 5 wt % to 10 wt % of acryloylmorpholine, 5 wt % to 10 wt % of a co-initiator, 0.5 wt % to 1.5 wt % of polyethylene wax, 4 wt % to 10 wt % of a photosensitizer, 0.5 wt % to 1.5 wt % of a thermal stabilizer and 5 wt % to 15 wt % of calcium carbonate.

In some embodiments of the present application, the aromatic polyurethane acrylic resin includes at least one of bifunctional aromatic polyurethane acrylic resin, trifunctional aromatic polyurethane acrylic resin, tetrafunctional aromatic polyurethane acrylic resin or hexafunctional aromatic polyurethane acrylic resin.

In some embodiments of the present application, the modified epoxy acrylic resin includes at least one of rosin-modified epoxy acrylic resin, aldehyde-ketone-modified epoxy acrylic resin, or phenol formaldehyde-modified epoxy acrylic resin.

In some embodiments of the present application, the photosensitizer includes at least one of benzophenone, 2-methyl-1-[4-methylthiophenyl]-2-morpholinyl-1-propanone, N-(ethoxycarbonylphenyl)-N′-methyl-N′-phenylformamidine, bis(2,2,6,6-tetramethyl-4-piperidyl) sebacate, (2,4,6-trimethylbenzoyl)diphenyl phosphine oxide, isopropylthioxanthraquinone, 2,4-diethylthioxanthone, 2-phenylbenzyl-2-dimethylamino-1-(4-morpholinobenzylphenyl)-butanone or 1-hydroxy-cyclohexyl-phenyl ketone.

In some embodiments of the present application, the calcium carbonate has a particle size in a range of 1000 meshes to 10000 meshes.

In some embodiments of the present application, the thermochromic ink has a particle size of less than 5 μm.

A second aspect of the present application is to provide a method for preparing the thermochromic ink described above. The method includes the following steps:
S1, aromatic polyurethane acrylic resin, modified epoxy acrylic resin, ethoxylated trimethylolpropane triacrylate, 1,6-hexanediol diacrylate, tetrahydrofuran acrylate, acryloylmorpholine, a co-initiator, polyethylene wax, a photosensitizer, a thermal stabilizer and calcium carbonate are mixed, stirred uniformly, and then allowed to stand for a predetermined time to enable the resulting mixed pigment to be sufficiently wetted;
S2, after the predetermined time, the mixed pigment is ground to a predetermined fineness.

In some embodiments of the present application, the stirring is carried out for 30 min to 50 min, and the predetermined time is greater than 4 h.

In some embodiments of the present application, the aromatic polyurethane acrylic resin includes at least one of bifunctional aromatic polyurethane acrylic resin, trifunctional aromatic polyurethane acrylic resin, tetrafunctional aromatic polyurethane acrylic resin or hexafunctional aromatic polyurethane acrylic resin.

In some embodiments of the present application, the modified epoxy acrylic resin includes at least one of rosin-modified epoxy acrylic resin, aldehyde-ketone-modified epoxy acrylic resin, or phenol formaldehyde-modified epoxy acrylic resin.

In some embodiments of the present application, the photosensitizer includes at least one of benzophenone, 2-methyl-1-[4-methylthiophenyl]-2-morpholinyl-1-propanone, N-(ethoxycarbonylphenyl)-N′-methyl-N′-phenylformamidine, bis(2,2,6,6-tetramethyl-4-piperidyl) sebacate, (2,4,6-trimethylbenzoyl)diphenyl phosphine oxide, isopropylthioxanthraquinone, 2,4-diethylthioxanthone, 2-phenylbenzyl-2-dimethylamino-1-(4-morpholinobenzylphenyl)-butanone or 1-hydroxy-cyclohexyl-phenyl ketone.

In some embodiments of the present application, the calcium carbonate has a particle size in a range of 1000 meshes to 10000 meshes.

In some embodiments of the present application, the predetermined fineness is less than 5 μm.

A third aspect of the present application is to provide a printed product. The printed product includes a base paper and an ink layer, and the ink layer is formed by printing the thermochromic ink described above on the base paper.

In some embodiments of the present application, the ink layer has different colors over different temperature ranges.

In the present invention, by introducing an aromatic benzene ring-containing material, a co-initiator, a modified epoxy acrylic resin, and an active photosensitizer material with thermochromic properties into the ink formulation, the ink layer after drying can exhibit a pronounced color-changing effect under high-temperature conditions. The thermochromic ink of the present invention demonstrates a multi-stage, diversified color-changing effect across multiple ultra-high temperature ranges. When the temperature increases from 140° C. to 220° C., the color of the thermochromic ink of the present invention changes from colorless to pale yellow to deep yellow to light brown, and the color-changing effect is irreversible.

Additional aspects and advantages of the present invention are given in part in the following description, and part of them may become apparent from the following description or be learned through the practice of the present invention.

### BRIEF DESCRIPTION OF THE DRAWINGS

Drawings constituting a part of the present disclosure are intended to provide a further understanding of the present disclosure, and exemplary embodiments of the present disclosure and the description thereof are intended to explain the present disclosure and do not constitute improper limitations on the present disclosure. In the drawings:

FIG. 1 is a flowchart of a process for preparing an ink according to an embodiment of the present invention.

FIG. 2 shows the color-changing effect of the printed product produced in Example 1 of the present invention.

FIG. 3 shows the color-changing effect of the standard sample used in examples of the present invention.

FIG. 4 shows the color-changing effect of the printed product produced in Example 2 of the present invention.

FIG. 5 shows the color-changing effect of the printed product produced in Example 3 of the present invention.

FIG. 6 shows the color-changing effect of the printed product produced in Comparative Example 1 of the present invention.

FIG. 7 shows the color-changing effect of the printed product produced in Comparative Example 2 of the present invention.

### DETAILED DESCRIPTION

Only certain exemplary embodiments are briefly described below. As can be recognized by those skilled in the art, the described embodiments may be modified in various different ways without departing from the spirit or scope of the present invention. Therefore, the drawings and the description are considered as essentially illustrative rather than limitative.

Many different embodiments or examples are provided herein for implementing different structures of the present invention. To simplify the content of the present invention, components and arrangements of specific examples are described below. Certainly, they are only examples and are not intended to limit the present invention. Furthermore, the present invention may repeat reference numerals and/or reference letters in different examples, and this repetition is used for purposes of simplicity and clarity and itself does not indicate a relationship between the various embodiments and/or arrangements discussed. In addition, various examples of specific processes and materials are provided herein, but those ordinarily skilled in the art may recognize applications of other processes and/or the use of other materials.

“About” or “approximately” as used herein is inclusive of the stated value and means within an acceptable range of deviation for the particular value as determined by those skilled in the art, considering the measurement in question and the error associated with measurement of the particular quantity (i.e., the limitations of the measurement system). For example, “about” may mean within one or more standard deviations or within ±30%, ±20%, ±10% or ±5% of the stated value.

The present invention is described in detail below with reference to the drawings and embodiments for a better understanding of the solutions of the present invention and the advantages of various aspects thereof. However, the specific embodiments and examples described below are for the purpose of illustration only, rather than limiting the present invention.

The thermochromic ink provided by the present application includes the following raw materials: aromatic polyurethane acrylic resin, modified epoxy acrylic resin, ethoxylated trimethylolpropane triacrylate, 1,6-hexanediol diacrylate, tetrahydrofuran acrylate, acryloylmorpholine, a co-initiator, polyethylene wax, a photosensitizer, a thermal stabilizer, and calcium carbonate.

In the present invention, the aromatic polyurethane acrylic resin and the modified epoxy acrylic resin serve as the primary resins, and due to the inherent properties of their chemical groups, these resins can exhibit color changes at high temperatures. Ethoxylated trimethylolpropane triacrylate, 1,6-hexanediol diacrylate, tetrahydrofuran acrylate, and acryloylmorpholine function as diluents for the resins and may be used to adjust the viscosity of the ink as needed. Furthermore, in addition to their dilution effect, 1,6-hexanediol diacrylate, tetrahydrofuran acrylate and acryloylmorpholine may also provide good adhesion and flexibility for the ink.

The content of the aromatic polyurethane acrylic resin is 15 wt % to 45 wt %. In some embodiments of the present application, the content of the aromatic polyurethane acrylic resin may be 15 wt %, 17 wt %, 19 wt %, 21 wt %, 23 wt %, 25 wt %, 28 wt %, 30 wt %, 33 wt %, 35 wt %, 37 wt %, 40 wt %, or 45 wt %. Optionally, the aromatic polyurethane acrylic resin used in the present application includes at least one of bifunctional aromatic polyurethane acrylic resin, trifunctional aromatic polyurethane acrylic resin, tetrafunctional aromatic polyurethane acrylic resin or hexafunctional aromatic polyurethane acrylic resin.

The content of the modified epoxy acrylic resin is 5 wt % to 45 wt %. In some embodiments of the present application, the content of the modified epoxy acrylic resin may be 5 wt %, 8 wt %, 10 wt %, 12 wt %, 15 wt %, 17 wt %, 19 wt %, 22 wt %, 24 wt %, 26 wt %, 28 wt %, 30 wt %, 33 wt %, 35 wt %, 37 wt %, 40 wt % or 45 wt %. Optionally, the modified epoxy acrylic resin includes at least one of rosin-modified epoxy acrylic resin, aldehyde-ketone-modified epoxy acrylic resin, or phenol formaldehyde-modified epoxy acrylic resin.

The content of ethoxylated trimethylolpropane triacrylate (EO3TMPTA) is 5 wt % to 10 wt %. In some embodiments of the present application, the content of ethoxylated trimethylolpropane triacrylate may be 5 wt %, 6 wt %, 7 wt %, 8 wt %, 9 wt %, or 10 wt %.

The content of 1,6-hexanediol diacrylate (HDDA) is 5 wt % to 10 wt %. In some embodiments of the present application, the content of 1,6-hexanediol diacrylate may be 5 wt %, 7 wt %, 9 wt %, or 10 wt %.

The content of tetrahydrofuran acrylate (THFA) is 5 wt % to 10 wt %. In some embodiments of the present application, the content of tetrahydrofuran acrylate may be 5 wt %, 7 wt %, 9 wt %, or 10 wt %.

The content of acryloylmorpholine (ACMO) is 5 wt % to 10 wt %. In some embodiments of the present application, the content of acryloylmorpholine may be 5 wt %, 7 wt %, 9 wt %, or 10 wt %.

The content of the co-initiator is 5 wt % to 10 wt %. In some embodiments of the present application, the content of the co-initiator may be 5 wt %, 7 wt %, 9 wt %, or 10 wt %. Optionally, the co-initiator is an active amine, such as active amine P113.

The content of polyethylene wax is 0.5 wt % to 1.5 wt %. Polyethylene wax is mainly used to provide abrasive resistance in the present invention. In some embodiments of the present application, the content of polyethylene wax may be 0.5 wt %, 1 wt %, or 1.5 wt %.

The content of the photosensitizer is 4 wt % to 10 wt %. Optionally, the photosensitizer includes at least one of benzophenone, 2-methyl-1-[4-methylthiophenyl]-2-morpholinyl-1-propanone, N-(ethoxycarbonylphenyl)-N′-methyl-N′-phenylformamidine, bis(2,2,6,6-tetramethyl-4-piperidyl) sebacate, (2,4,6-trimethylbenzoyl)diphenyl phosphine oxide, isopropylthioxanthraquinone (mixture of 2 and 4 isomers), 2,4-diethylthioxanthone, 2-phenylbenzyl-2-dimethylamino-1-(4-morpholinobenzylphenyl)-butanone or 1-hydroxy-cyclohexyl-phenyl ketone. When used in combination, the above photosensitizers may reduce the drying time of the ink. In some embodiments of the present application, the content of the photosensitizer may be 4 wt %, 5 wt %, 6 wt %, 7 wt %, 8 wt %, or 10 wt %. For example, the content of 2-methyl-1-[4-(methylthio)phenyl]-2-(4-morpholinyl)-1-propanone may be 3 wt % to 5 wt %, the content of 2,4-diethylthioxanthone may be 1 wt % to 3 wt %, and the content of 2-phenylbenzyl-2-dimethylamino-1-(4-morpholinobenzylphenyl)-butanone may be 1 wt % to 3 wt %.

The content of the thermal stabilizer is 0.5 wt % to 1.5 wt %. The thermal stabilizer is mainly used to improve the storage stability of the ink of the present invention. In some embodiments of the present application, the content of the thermal stabilizer may be 0.5 wt %, 1 wt %, or 1.5 wt %.

The content of calcium carbonate is 5 wt % to 15 wt %. The calcium carbonate used in the present invention has a particle size of less than 5 μm and a particle size distribution of 1000 meshes to 10000 meshes. In some embodiments of the present application, the content of calcium carbonate may be 5 wt %, 7 wt %, 9 wt %, 11 wt %, 13 wt %, or 15 wt %.

Optionally, the thermochromic ink has a particle size of less than 5 μm.

In the present invention, by introducing an aromatic benzene ring-containing material, a co-initiator, modified epoxy acrylic resin, and a photosensitizer material with thermochromic properties into the ink formulation, the ink layer after drying can exhibit a pronounced color-changing effect under high-temperature conditions. The thermochromic ink of the present invention demonstrates a multi-stage, diversified color-changing effect across multiple ultra-high temperature ranges. When the temperature increases from 140° C. to 220° C., the color of the thermochromic ink of the present invention changes from colorless to pale yellow to deep yellow to light brown, and the color-changing effect is irreversible.

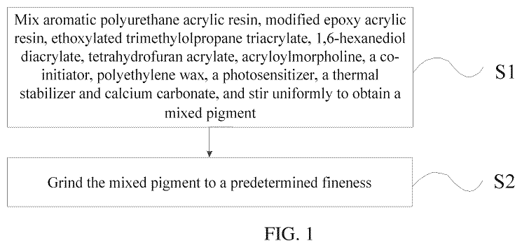

FIG. 1 shows a method for preparing the ink described above according to an embodiment of the present invention. The method includes steps S1 and S2.

S1, aromatic polyurethane acrylic resin, modified epoxy acrylic resin, ethoxylated trimethylolpropane triacrylate, 1,6-hexanediol diacrylate, tetrahydrofuran acrylate, acryloylmorpholine, a co-initiator, polyethylene wax, a photosensitizer, a thermal stabilizer and calcium carbonate are mixed, stirred uniformly, and then allowed to stand for a predetermined time to enable the resulting mixed pigment to be sufficiently wetted.

Optionally, the stirring is carried out by using a planetary mixer. Further, optionally, the stirring is carried out for 30 min to 50 min. In some specific embodiments, the stirring may be carried out for 30 min, 35 min, 40 min, 45 min, or 50 min.

Optionally, the predetermined time is greater than 4 h. The mixed pigment is left for more than 4 h until the mixed pigment is sufficiently wetted, then ground.

S2, after the predetermined time, the mixed pigment is ground to a predetermined fineness.

Optionally, the mixed pigment is ground by a three-roll grinder at least two times, so that the mixed pigment may reach the predetermined fineness. The pressure of the three-roller grinder may be set according to the fineness requirements, and the fineness is detected by a fineness meter. Optionally, the predetermined fineness is less than 5 μm.

Optionally, the prepared ink is degassed by using the three-roll grinder and then may be packaged.

The present application further provides a printed product. The printed product includes a base paper and an ink layer, and the ink layer is formed by printing the thermochromic ink described above on the base paper. The ink may be printed on the surface of the paper by offset printing, flexographic printing, screen printing, or roller coating.

The ink layer of the printed product provided by the present invention has different colors over different temperature ranges and demonstrates a diversified color-changing effect. When the temperature increases from 140° C. to 220° C., the color of the thermochromic ink of the present invention changes from colorless to pale yellow to deep yellow to light brown, and the color-changing effect is irreversible.

The present invention is described below with reference to specific examples. The numerical values of the process conditions taken in the following examples are all exemplary, and the possible numerical ranges thereof are as shown in the above summary part. As for the process parameters not specifically indicated, reference may be made to the conventional techniques. Unless otherwise specified, the detection methods used in the following examples are all conventional detection methods in the art. Unless otherwise specified, the reagents and instruments used in the technical solutions provided by the present invention may be purchased from conventional channels or be commercially available.

### Example 1

This example provides a printed product, and the base material of the printed product is a PVC film. Specific preparation steps are as follows:

First, bifunctional aromatic polyurethane acrylic resin, rosin-modified epoxy acrylic resin, ethoxylated trimethylolpropane triacrylate, 1,6-hexanediol diacrylate, tetrahydrofuran acrylate, acryloylmorpholine, a co-initiator, polyethylene wax, a photosensitizer, a thermal stabilizer and calcium carbonate were mixed according to the mass percentages shown in Table 1 and stirred uniformly to obtain a mixed pigment. The mixed pigment was left for 6.5 h to enable the mixed pigment to be sufficiently wetted. Then, the mixed pigment was ground in a three-roll grinder until the fineness of the mixed pigment was less than 5 μm, so as to obtain the desired ink.

TABLE 1
Raw materials used in Example 1

| | | | Percentage | |
|---|---|---|---|---|
| | | Catalog | by mass | |
| Material | Manufacturer | Number | (wt %) | Property |
| Bifunctional aromatic | ZHONGSHAN | UV2021 | 25 | Elongation rate, |
| polyurethane acrylic resin | QIANYOU | | | 6%; color |
| | CHEMICAL | | | changing at |
| | MATERIALS CO., | | | high |
| | LTD. (CHINA) | | | temperatures |
| Rosin-modified epoxy | XIAMEN ACOMA | UV-100A | 10 | Plant-based |
| acrylic resin | CHEMICAL | | | content: >20%; |
| | MATERIALS CO., | | | color changing |
| | LTD. (CHINA) | | | at high |
| | | | | temperatures |
| Ethoxylated | ETERNAL | EM2380TF | 10 | Viscosity (cps |
| trimethylolpropane | MATERIALS | | | at 25° C.): 50-70 |
| triacrylate | INDUSTRIAL CO., | | | |
| | LTD. (TAIWAN, | | | |
| | CHINA) | | | |
| 1,6-hexanediol diacrylate | ETERNAL | EM221TF | 8 | Viscosity (cps |
| | MATERIALS | | | at 25° C.): 5-10 |
| | INDUSTRIAL CO., | | | |
| | LTD. (TAIWAN, | | | |
| | CHINA) | | | |
| Tetrahydrofuran acrylate | MIWON | M150 | 8 | Viscosity (cps |
| | SPECIALTY | | | at 25° C.): 5-6; |
| | CHEMICAL CO., | | | enhancing |
| | LTD. (SOUTH | | | flexibility and |
| | KOREA) | | | adhesion |
| Acryloylmorpholine | GUANGDONG | L6102 | 8 | Viscosity (cps |
| | LENCOLO NEW | | | at 25° C.): 5-6; |
| | MATERIAL CO., | | | enhancing |
| | LTD. (CHINA) | | | flexibility and |
| | | | | adhesion |
| Co-initiator | ZHONGSHAN | Active | 8 | Co-initiator, |
| | QIANYOU | amine P113 | | color changing |
| | CHEMICAL | | | at high |
| | MATERIALS CO., | | | temperatures |
| | LTD. (CHINA) | | | |
| Polyethylene wax | CLARIANT | 9610F | 1 | Enhancing |
| | CHEMICALS | | | scratch |
| | (CHINA) LTD. | | | resistance |
| 2-methyl-1-[4- | TIANJIN JIURI | JRcure | 3 | Tack-free; color |
| (methylthio)phenyl]-2-(4- | NEW MATERIALS | 1107 | | changing at |
| morpholinyl)-1-propanone | CO., LTD. | | | high |
| | | | | temperatures |
| 2,4-diethylthioxanthone | TIANJIN JIURI | JRcure | 3 | Deep curing; |
| | NEW MATERIALS | 1106 | | color changing |
| | CO., LTD. | | | at high |
| | | | | temperatures |
| 2-phenylbenzyl-2- | IGM RESINS B.V. | Omnirad | 2 | Deep curing; |
| dimethylamino-1-(4- | (NETHERLANDS) | 369 | | color changing |
| morpholinobenzylphenyl)- | | | | at high |
| butanone | | | | temperatures |
| Thermal stabilizer | RHODIA | MEHQ | 1 | Providing |
| | CORPORATE | | | storage stability |
| | (FRANCE) | | | |
| Nano calcium carbonate | SHANGHAI | SP-100 | 13 | Particle size: 20 |
| | PERFECTION | | | nm-100 nm |
| | NANOMETRE | | | |
| | NEW MATERIAL | | | |
| | CO., LTD. (CHINA) | | | |

### Example 2

This example provides a printed product, and the base material of the printed product is a PVC film. The specific preparation steps are the same as the preparation steps of Example 1.

TABLE 2
Raw materials used in Example 2

| | | | Percentage | |
|---|---|---|---|---|
| | | Catalog | by mass | |
| Material | Manufacturer | Number | (wt %) | Property |
| Bifunctional aromatic | ZHONGSHAN | UV2021 | 20 | Elongation |
| polyurethane acrylic | QIANYOU | | | rate, 6%; color |
| resin | CHEMICAL | | | changing at |
| | MATERIALS CO., | | | high |
| | LTD. (CHINA) | | | temperatures |
| Rosin-modified epoxy | XIAMEN ACOMA | UV-100A | 6 | Plant-based |
| acrylic resin | CHEMICAL | | | content: >20%; |
| | MATERIALS CO., | | | color changing |
| | LTD. (CHINA) | | | at high |
| | | | | temperatures |
| phenol formaldehyde- | ALLNEX RESINS | EB9636 | 4 | Viscosity (cps |
| modified epoxy acrylic | (SHANGHAI) CO., | | | at 25° C.): |
| resin | LTD. | | | 25000 |
| Ethoxylated | ETERNAL | EM2380TF | 10 | Viscosity (cps |
| trimethylolpropane | MATERIALS | | | at 25° C.): 50- |
| triacrylate | INDUSTRIAL CO., | | | 70 |
| | LTD. (TAIWAN, | | | |
| | CHINA) | | | |
| 1,6-hexanediol diacrylate | ETERNAL | EM221TF | 8 | Viscosity (cps |
| | MATERIALS | | | at 25° C.): 5-10 |
| | INDUSTRIAL CO., | | | |
| | LTD. (TAIWAN, | | | |
| | CHINA) | | | |
| Tetrahydrofuran acrylate | MIWON SPECIALTY | M150 | 10 | Viscosity (cps |
| | CHEMICAL CO., | | | at 25° C.): 5-6; |
| | LTD. (SOUTH | | | enhancing |
| | KOREA) | | | flexibility and |
| | | | | adhesion |
| Acryloylmorpholine | GUANGDONG | L6102 | 8 | Viscosity (cps |
| | LENCOLO NEW | | | at 25° C.): 5-6; |
| | MATERIAL CO., LTD. | | | enhancing |
| | (CHINA) | | | flexibility and |
| | | | | adhesion |
| Co-initiator | ZHONGSHAN | Active | 10 | Co-initiator, |
| | QIANYOU | amine | | color changing |
| | CHEMICAL | P113 | | at high |
| | MATERIALS CO., | | | temperatures |
| | LTD. (CHINA) | | | |
| Polyethylene wax | CLARIANT | 9610F | 1.2 | Enhancing |
| | CHEMICALS | | | scratch |
| | (CHINA) LTD. | | | resistance |
| 2-methyl-1-[4- | TIANJIN JIURI NEW | JRcure | 8 | Tack-free, |
| (methylthio)phenyl]-2- | MATERIALS CO., | 1107 | | color changing |
| (4-morpholiny1)-1- | LTD. | | | at high |
| propanone | | | | temperatures |
| Thermal stabilizer | RHODIA | MEHQ | 0.8 | Providing |
| | CORPORATE | | | storage |
| | (FRANCE) | | | stability |
| Nano calcium carbonate | SHANGHAI | SP-100 | 14 | Particle size: |
| | PERFECTION | | | 20 nm-100 nm |
| | NANOMETRE NEW | | | |
| | MATERIAL CO., LTD. | | | |
| | (CHINA) | | | |

### Example 3

This example provides a printed product, and the base material of the printed product is a PVC film. The specific preparation steps are the same as the preparation steps of Example 1.

TABLE 3
Raw materials used in Example 3

| | | | Percentage | |
|---|---|---|---|---|
| | | Catalog | by mass | |
| Material | Manufacturer | Number | (wt %) | Property |
| Hexafunctional aromatic | ETERNAL | Etercure61 | 20 | Elongation |
| polyurethane acrylic resin | MATERIALS | 45-100 | | rate, 6%; color |
| | INDUSTRIAL CO., | | | changing at |
| | LTD. (TAIWAN, | | | high |
| | CHINA) | | | temperatures |
| Aldehyde-ketone- | ZHONGSHAN | UV1005- | 10 | Viscosity (cps |
| modified epoxy acrylic | QIANYOU CHEMICAL | 65 | | at 25° C.): |
| resin | MATERIALS CO., LTD. | | | 30000-50000 |
| | (CHINA) | | | |
| Ethoxylated | ETERNAL | EM2380TF | 10 | Viscosity (cps |
| trimethylolpropane | MATERIALS | | | at 25° C.): 50- |
| triacrylate | INDUSTRIAL CO., | | | 70 |
| | LTD. (TAIWAN, | | | |
| | CHINA) | | | |
| 1,6-hexanediol diacrylate | ETERNAL | EM221TF | 10 | Viscosity (cps |
| | MATERIALS | | | at 25° C.): 5-10 |
| | INDUSTRIAL CO., | | | |
| | LTD. (TAIWAN, | | | |
| | CHINA) | | | |
| Tetrahydrofuran acrylate | MIWON SPECIALTY | M150 | 10 | Viscosity (cps |
| | CHEMICAL CO., LTD. | | | at 25° C.): 5-6; |
| | (SOUTH KOREA) | | | enhancing |
| | | | | flexibility and |
| | | | | adhesion |
| Acryloylmorpholine | GUANGDONG | L6102 | 10 | Viscosity (cps |
| | LENCOLO NEW | | | at 25° C.): 5-6; |
| | MATERIAL CO., LTD. | | | enhancing |
| | (CHINA) | | | flexibility and |
| | | | | adhesion |
| Co-initiator | ZHONGSHAN | Active | 8 | Co-initiator, |
| | QIANYOU CHEMICAL | amine | | color changing |
| | MATERIALS CO., LTD. | P113 | | at high |
| | (CHINA) | | | temperatures |
| Polyethylene wax | CLARIANT | 9610F | 1 | Enhancing |
| | CHEMICALS (CHINA) | | | scratch |
| | LTD. | | | resistance |
| Benzophenone | TIANJIN JIURI NEW | JRCure- | 3 | Tack-free, |
| | MATERIALS CO., LTD. | 1020 | | color changing |
| | | | | at high |
| | | | | temperatures |
| N- | QINGDAO JADE NEW | UV 1 | 2 | Providing |
| (ethoxycarbonylphenyl)- | MATERIAL | | | stability |
| N′-methyl-N′- | TECHNOLOGY CO., | | | |
| phenylformamidine | LTD. (CHINA) | | | |
| Thermal stabilizer | RHODIA CORPORATE | MEHQ | 1 | Providing |
| | (FRANCE) | | | storage |
| | | | | stability |
| Nano calcium carbonate | SHANGHAI | SP-100 | 15 | Particle size: |
| | PERFECTION | | | 20 nm-100 nm |
| | NANOMETRE NEW | | | |
| | MATERIAL CO., LTD. | | | |
| | (CHINA) | | | |

### Comparative Example 1

This comparative example provides a printed product, and the base material of the printed product is a PVC film. The specific preparation steps are the same as the preparation steps of Example 1.

TABLE 4
Raw materials used in Comparative Example 1

| | | | Percentage | |
|---|---|---|---|---|
| | | Catalog | by mass | |
| Material | Manufacturer | Number | (wt %) | Property |
| Rosin-modified epoxy | XIAMEN ACOMA | UV-100A | 26 | Plant-based |
| acrylic resin | CHEMICAL | | | content: >20%; |
| | MATERIALS CO., | | | color changing |
| | LTD. (CHINA) | | | at high |
| | | | | temperatures |
| Ethoxylated | ETERNAL | EM2380TF | 10 | Viscosity (cps |
| trimethylolpropane | MATERIALS | | | at 25° C.): 50- |
| triacrylate | INDUSTRIAL CO., | | | 70 |
| | LTD. (TAIWAN, | | | |
| | CHINA) | | | |
| 1,6-hexanediol diacrylate | ETERNAL | EM221TF | 10 | Viscosity (cps |
| | MATERIALS | | | at 25° C.): 5-10 |
| | INDUSTRIAL CO., | | | |
| | LTD. (TAIWAN, | | | |
| | CHINA) | | | |
| Tetrahydrofuran acrylate | MIWON SPECIALTY | M150 | 10 | Viscosity (cps |
| | CHEMICAL CO., | | | at 25° C.): 5-6; |
| | LTD. (SOUTH | | | enhancing |
| | KOREA) | | | flexibility and |
| | | | | adhesion |
| Acryloylmorpholine | GUANGDONG | L6102 | 10 | Viscosity (cps |
| | LENCOLO NEW | | | at 25° C.): 5-6; |
| | MATERIAL CO., | | | enhancing |
| | LTD. (CHINA) | | | flexibility and |
| | | | | adhesion |
| Co-initiator | ZHONGSHAN | Active | 10 | Co-initiator, |
| | QIANYOU | amine | | color changing |
| | CHEMICAL | P113 | | at high |
| | MATERIALS CO., | | | temperatures |
| | LTD. (CHINA) | | | |
| Polyethylene wax | CLARIANT | 9610F | 1 | Enhancing |
| | CHEMICALS | | | scratch |
| | (CHINA) LTD. | | | resistance |
| 2-methyl-1-[4- | TIANJIN JIURI NEW | JRcure | 3 | Tack-free, |
| (methylthio)phenyl]-2-(4- | MATERIALS CO., | 1107 | | color changing |
| morpholinyl)-1-propanone | LTD. | | | at high |
| | | | | temperatures |
| 2,4-diethylthioxanthone | TIANJIN JIURI NEW | JRcure | 3 | Deep curing, |
| | MATERIALS CO., | 1106 | | color changing |
| | LTD. | | | at high |
| | | | | temperatures |
| 2-phenylbenzyl-2- | IGM Resins B.V. | Omnirad | 3 | Deep curing, |
| dimethylamino-1-(4- | (Netherlands) | 369 | | color changing |
| morpholinobenzylphenyl)- | | | | at high |
| butanone | | | | temperatures |
| Thermal stabilizer | RHODIA | MEHQ | 1 | Providing |
| | CORPORATE | | | storage |
| | (FRANCE) | | | stability |
| Nano calcium carbonate | SHANGHAI | SP-100 | 13 | Particle size: |
| | PERFECTION | | | 20 nm-100 nm |
| | NANOMETRE NEW | | | |
| | MATERIAL CO., | | | |
| | LTD. (CHINA) | | | |

### Comparative Example 2

This comparative example provides a printed product, and the base material of the printed product is a PVC film. The specific preparation steps are the same as the preparation steps of Example 1.

TABLE 5
Raw materials used in Comparative Example 2

| | | | Percentage | |
|---|---|---|---|---|
| | | Catalog | by mass | |
| Material | Manufacturer | Number | (wt %) | Property |
| Bifunctional aromatic | ZHONGSHAN | UV2021 | 30 | Elongation |
| polyurethane acrylic resin | QIANYOU | | | rate, 6%; color |
| | CHEMICAL | | | changing at |
| | MATERIALS CO., | | | high |
| | LTD. (CHINA) | | | temperatures |
| Ethoxylated | ETERNAL | EM2380TF | 10 | Viscosity (cps |
| trimethylolpropane | MATERIALS | | | at 25° C.): 50- |
| triacrylate | INDUSTRIAL CO., | | | 70 |
| | LTD. (TAIWAN, | | | |
| | CHINA) | | | |
| 1,6-hexanediol diacrylate | ETERNAL | EM221TF | 8 | Viscosity (cps |
| | MATERIALS | | | at 25° C.): 5- |
| | INDUSTRIAL CO., | | | 10 |
| | LTD. (TAIWAN, | | | |
| | CHINA) | | | |
| Tetrahydrofuran acrylate | MIWON SPECIALTY | M150 | 10 | Viscosity (cps |
| | CHEMICAL CO., | | | at 25° C.): 5-6; |
| | LTD. (SOUTH | | | enhancing |
| | KOREA) | | | flexibility and |
| | | | | adhesion |
| Acryloylmorpholine | GUANGDONG | L6102 | 8 | Viscosity (cps |
| | LENCOLO NEW | | | at 25° C.): 5-6; |
| | MATERIAL CO., | | | enhancing |
| | LTD. (CHINA) | | | flexibility and |
| | | | | adhesion |
| Co-initiator | ZHONGSHAN | Active | 10 | Co-initiator, |
| | QIANYOU | amine | | color changing |
| | CHEMICAL | P113 | | at high |
| | MATERIALS CO., | | | temperatures |
| | LTD. (CHINA) | | | |
| Polyethylene wax | CLARIANT | 9610F | 1 | Enhancing |
| | CHEMICALS | | | scratch |
| | (CHINA) LTD. | | | resistance |
| 2-methyl-1-[4- | TIANJIN JIURI NEW | JRcure | 3 | Tack-free, |
| (methylthio)phenyl]-2-(4- | MATERIALS CO., | 1107 | | color changing |
| morpholinyl)-1-propanone | LTD. | | | at high |
| | | | | temperatures |
| 2,4-diethylthioxanthone | TIANJIN JIURI NEW | JRcure | 3 | Deep curing, |
| | MATERIALS CO., | 1106 | | color changing |
| | LTD. | | | at high |
| | | | | temperatures |
| 2-phenylbenzyl-2- | IGM Resins B.V. | Omnirad | 3 | Deep curing, |
| dimethylamino-1-(4- | (Netherlands) | 369 | | color changing |
| morpholinobenzylphenyl)- | | | | at high |
| butanone | | | | temperatures |
| Thermal stabilizer | RHODIA | MEHQ | 1 | Providing |
| | CORPORATE | | | storage |
| | (FRANCE) | | | stability |
| Calcium carbonate | SHANGHAI | SP-100 | 13 | Particle size: |
| | PERFECTION | | | 20 nm-100 |
| | NANOMETRE NEW | | | nm |
| | MATERIAL CO., | | | |
| | LTD. (CHINA) | | | |

### Experimental Example

The properties of the inks in Examples and Comparative Examples were tested separately using the following methods.

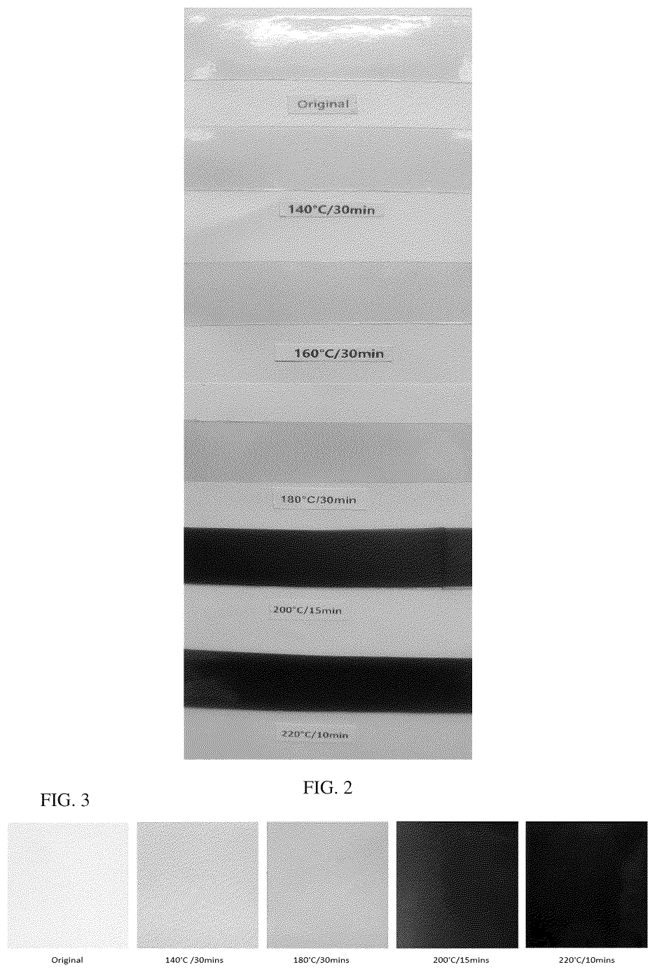

An appropriate amount of the thermochromic ink was applied onto a PVC film serving as a base material using an ink knife, coated uniformly using a 10 μm wire-wound bar on the base material, then cured in a UV machine after a draw-down film was prepared. After drying, the cured samples are tested for a high-temperature color-changing effect in an oven set at 126° C., 137° C., 148° C., 180° C. and 210° C. The resulting color-changing effect was deemed acceptable if consistent with the color-changing effect of the standard sample. The resulting color-changing effect is shown in FIG. 2, and the color-changing effect of the standard sample is shown in FIG. 3. The standard sample was prepared by coating the ink on a PVC film, and after drying, the standard sample was tested for a high-temperature color-changing effect in an oven set at 140° C., 180° C., 200° C., and 220° C. in a laboratory.

The ink was tested for fineness, viscosity, and fluidity by using a fineness gauge, an ink meter and a flowmeter, respectively. Curing/drying properties of the ink were determined through curing tests. The test results are shown in Table 2.

The draw-down film thus obtained was folded once and examined for cracking. The examination result shows that no cracks were observed.

A 3M 610 tape was firmly applied to the printed surface of the draw-down film and then rapidly removed at an angle of 90° to observe whether any ink was torn off by the tape. The observation result shows that no ink was torn off.

TABLE 6
Property parameters of the ink of Examples and Comparative Examples

| | | | | Comparative | Comparative |
|---|---|---|---|---|---|
| | Example 1 | Example 2 | Example 3 | Example 1 | Example 2 |
| Fineness/μm | 5 | 5 | 5 | 5 | 5 |
| Viscosity/mpa · s | 800 | 750 | 920 | 1300 | 760 |
| Curing energy | 280 | 280 | 280 | 280 | 280 |
| (mj/cm²) | | | | | |
| Adhesion | 100/100 | 100/100 | 20/100 | 10/100 | 100/100 |
| (with 3M tapes) | | | | | |

As shown in FIG. 2, the printed product of Example 1 of the present application exhibited no color change at 140° C.; the color of the printed product started to change at 160° C.; from 140° C. to 220° C., the color of the printed product experienced the following changes: colorless-pale yellow-deep yellow-light brown, and the color-changing effect was irreversible. As can be seen from FIG. 2 and FIG. 3, the printed product of the present application and the standard sample were substantially consistent in color-changing effects.

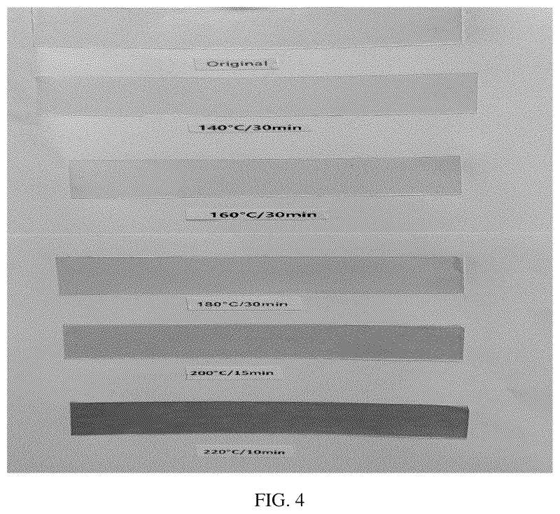

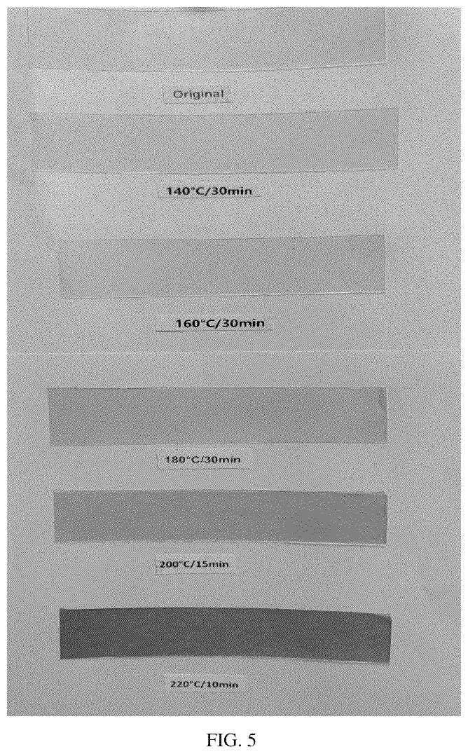

As shown in FIG. 4, the printed product of Example 2 of the present application exhibited no color change at 140° C.; the color of the printed product started to change at 160° C.; when the temperature increased from 140° C. to 220° C., the color of the printed product changed from colorless to pale yellow to deep yellow to light brown, and the color-changing effect was irreversible.

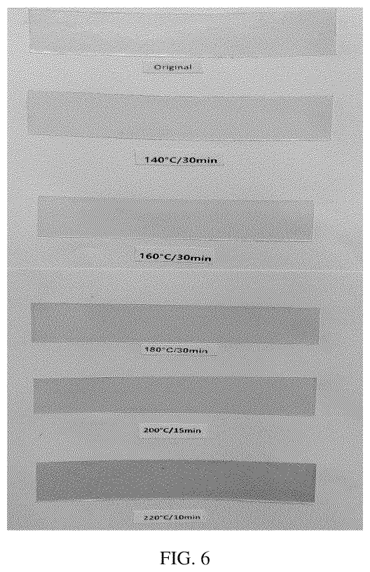

As shown in FIG. 5, the printed product of Example 3 of the present application exhibited no color change at 140° C.; the color of the printed product started to change at 160° C.; when the temperature increased from 140° C. to 220° C., the color of the printed product changed from colorless to pale yellow to deep yellow to light brown, and the color-changing effect was irreversible.

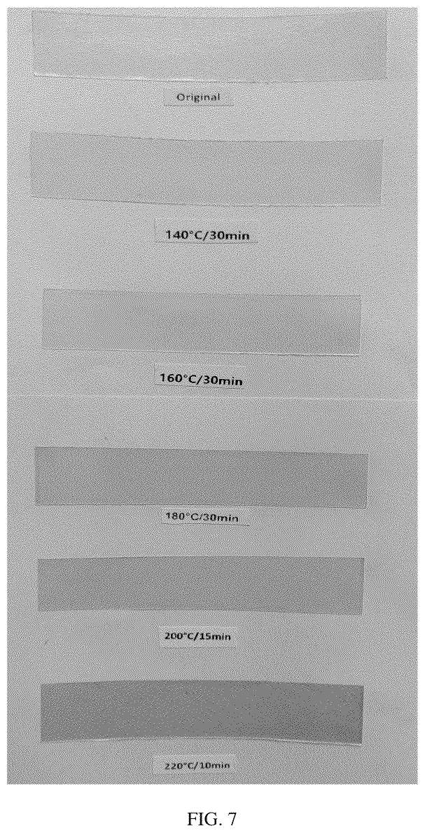

As shown in FIGS. 6 and 7, the colors of the printed products of Comparative Examples 1 and 2 of the present application did not change at both 140° C. and 160° C. and then started to change at 180° C.; when the temperature increased from 140° C. to 220° C., the colors of the printed products changed from colorless to pale yellow to yellow to light brown.

As can be seen from FIG. 6, the print adaptability of the thermochromic ink of the present application was also excellent. According to Comparative Example 1, the omission of aromatic polyurethane acrylic resin resulted in elevated viscosity and severe adhesion failure of the prepared ink, and the thermochromic coating was almost completely delaminated during adhesion testing. Although the high-temperature color changing effect of the printed product of Comparative Example 1 was marginally acceptable, the color change was not as deep as that in Example 1, as shown in FIG. 6. In Comparative Example 2, the omission of modified epoxy acrylic resin did not affect the adhesion but caused significantly less pronounced color changes compared to Example 1, as shown in FIG. 7. Example 3 employed a different modified epoxy acrylic resin in the ink formulation and consequently achieved a poorer color-changing effect than Example 1, as shown in FIG. 5. Example 2 exhibited reduced color depth compared to Example 1 due to a decrease in the content of rosin-modified epoxy acrylic resin, as shown in FIG. 4.

Finally, it should be noted that the above are merely preferred embodiments of the present invention and are not intended to limit the present invention. Although the present invention has been described in detail with reference to the preceding embodiments, those skilled in the art can still modify the technical solutions described in the preceding embodiments or make equivalent substitutions on part of the technical features therein. Any modifications, equivalent substitutions, improvements and the like made within the spirit and principle of the present invention are within the scope of the present invention.

1. A thermochromic ink, comprising the following raw materials, in percentage by mass:
15 wt % to 45 wt % of aromatic polyurethane acrylic resin, 5 wt % to 45 wt % of modified epoxy acrylic resin, 5 wt % to 10 wt % of ethoxylated trimethylolpropane triacrylate, 5 wt % to 10 wt % of 1,6-hexanediol diacrylate, 5 wt % to 10 wt % of tetrahydrofuran acrylate, 5 wt % to 10 wt % of acryloylmorpholine, 5 wt % to 10 wt % of a co-initiator, 0.5 wt % to 1.5 wt % of polyethylene wax, 4 wt % to 10 wt % of a photosensitizer, 0.5 wt % to 1.5 wt % of a thermal stabilizer and 5 wt % to 15 wt % of calcium carbonate.

2. The thermochromic ink according to claim 1, wherein the aromatic polyurethane acrylic resin comprises at least one of bifunctional aromatic polyurethane acrylic resin, trifunctional aromatic polyurethane acrylic resin, tetrafunctional aromatic polyurethane acrylic resin or hexafunctional aromatic polyurethane acrylic resin.

3. The thermochromic ink according to claim 1, wherein the modified epoxy acrylic resin comprises at least one of rosin-modified epoxy acrylic resin, aldehyde-ketone-modified epoxy acrylic resin or phenol formaldehyde-modified epoxy acrylic resin.

4. The thermochromic ink according to claim 1, wherein the photosensitizer comprises at least one of benzophenone, 2-methyl-1-[4-methylthiophenyl]-2-morpholinyl-1-propanone, N-(ethoxycarbonylphenyl)-N′-methyl-N′-phenylformamidine, bis(2,2,6,6-tetramethyl-4-piperidyl) sebacate, (2,4,6-trimethylbenzoyl)diphenyl phosphine oxide, isopropylthioxanthraquinone, 2,4-diethylthioxanthone, 2-phenylbenzyl-2-dimethylamino-1-(4-morpholinobenzylphenyl)-butanone or 1-hydroxy-cyclohexyl-phenyl ketone.

5. The thermochromic ink according to claim 1, wherein the calcium carbonate has a particle size in a range of 1000 meshes to 10000 meshes.

6. The thermochromic ink according to claim 1, wherein the thermochromic ink has a particle size of less than 5 μm.

7. A method for preparing a thermochromic ink, comprising the following steps:
S1: mixing aromatic polyurethane acrylic resin, a modified epoxy acrylic resin, ethoxylated trimethylolpropane triacrylate, 1,6-hexanediol diacrylate, tetrahydrofuran acrylate, acryloylmorpholine, a co-initiator, polyethylene wax, a photosensitizer, a thermal stabilizer and calcium carbonate, and stirring uniformly to obtain a mixed pigment; and
S2: grinding the mixed pigment to a predetermined fineness.

8. The method according to claim 7, further comprising: before S2, allowing the mixed pigment to stand for a predetermined time.

9. The method according to claim 8, wherein the stirring is carried out for 30 min to 50 min, and the predetermined time is greater than 4 h.

10. The method according to claim 7, wherein the aromatic polyurethane acrylic resin comprises at least one of bifunctional aromatic polyurethane acrylic resin, trifunctional aromatic polyurethane acrylic resin, tetrafunctional aromatic polyurethane acrylic resin or hexafunctional aromatic polyurethane acrylic resin.

11. The method according to claim 7, wherein the modified epoxy acrylic resin comprises at least one of rosin-modified epoxy acrylic resin, aldehyde-ketone-modified epoxy acrylic resin or phenol formaldehyde-modified epoxy acrylic resin.

12. The method according to claim 7, wherein the photosensitizer comprises at least one of benzophenone, 2-methyl-1-[4-methylthiophenyl]-2-morpholinyl-1-propanone, N-(ethoxycarbonylphenyl)-N′-methyl-N′-phenylformamidine, bis(2,2,6,6-tetramethyl-4-piperidyl) sebacate, (2,4,6-trimethylbenzoyl)diphenyl phosphine oxide, isopropylthioxanthraquinone, 2,4-diethylthioxanthone, 2-phenylbenzyl-2-dimethylamino-1-(4-morpholinobenzylphenyl)-butanone or 1-hydroxy-cyclohexyl-phenyl ketone.

13. The method according to claim 7, wherein the calcium carbonate has a particle size in a range of 1000 meshes to 10000 meshes.

14. The method according to claim 7, wherein the predetermined fineness is less than 5 μm.

15. A printed product, comprising a base paper and an ink layer, wherein the ink layer is formed by printing a thermochromic ink on the base paper, wherein the thermochromic ink comprises the following raw materials, in percentage by mass:
15 wt % to 45 wt % of aromatic polyurethane acrylic resin, 5 wt % to 45 wt % of modified epoxy acrylic resin, 5 wt % to 10 wt % of ethoxylated trimethylolpropane triacrylate, 5 wt % to 10 wt % of 1,6-hexanediol diacrylate, 5 wt % to 10 wt % of tetrahydrofuran acrylate, 5 wt % to 10 wt % of acryloylmorpholine, 5 wt % to 10 wt % of a co-initiator, 0.5 wt % to 1.5 wt % of polyethylene wax, 4 wt % to 10 wt % of a photosensitizer, 0.5 wt % to 1.5 wt % of a thermal stabilizer and 5 wt % to 15 wt % of calcium carbonate.

16. The printed product according to claim 15, wherein the aromatic polyurethane acrylic resin comprises at least one of bifunctional aromatic polyurethane acrylic resin, trifunctional aromatic polyurethane acrylic resin, tetrafunctional aromatic polyurethane acrylic resin or hexafunctional aromatic polyurethane acrylic resin.

17. The printed product according to claim 15, wherein the modified epoxy acrylic resin comprises at least one of rosin-modified epoxy acrylic resin, aldehyde-ketone-modified epoxy acrylic resin or phenol formaldehyde-modified epoxy acrylic resin.

18. The printed product according to claim 15, wherein the photosensitizer comprises at least one of benzophenone, 2-methyl-1-[4-methylthiophenyl]-2-morpholinyl-1-propanone, N-(ethoxycarbonylphenyl)-N′-methyl-N′-phenylformamidine, bis(2,2,6,6-tetramethyl-4-piperidyl) sebacate, (2,4,6-trimethylbenzoyl)diphenyl phosphine oxide, isopropylthioxanthraquinone, 2,4-diethylthioxanthone, 2-phenylbenzyl-2-dimethylamino-1-(4-morpholinobenzylphenyl)-butanone or 1-hydroxy-cyclohexyl-phenyl ketone.

19. The printed product according to claim 15, wherein the calcium carbonate has a particle size in a range of 1000 meshes to 10000 meshes, and the thermochromic ink has a particle size of less than 5 μm.

20. The printed product according to claim 15, wherein the ink layer has different colors over different temperature ranges.
